(19) United States
(12) Patent Application Publication
(10) Pub. No.: US 2013/0169017 A1
(43) Pub. Date: Jul. 4, 2013

(54) CHAIR

(71) Applicants: Hiroshi Masunaga, Yokohama-shi (JP); Yoichiro Oda, Yokohama-shi (JP); Hisato Fujita, Yokohama-shi (JP); Shoichi Izawa, Tokyo (JP); Ryo Igarashi, Tokyo (JP)

(72) Inventors: Hiroshi Masunaga, Yokohama-shi (JP); Yoichiro Oda, Yokohama-shi (JP); Hisato Fujita, Yokohama-shi (JP); Shoichi Izawa, Tokyo (JP); Ryo Igarashi, Tokyo (JP)

(73) Assignee: OKAMURA CORPORATION, Yokohama (JP)

(21) Appl. No.: 13/703,182

(22) PCT Filed: Jun. 9, 2011
(86) PCT No.: PCT/JP2011/063231

§ 371 Date: Mar. 20, 2013

(30) Foreign Application Priority Data
Jun. 11, 2010 (JP) 2010-133747
Jun. 11, 2010 (JP) 2010-133748
Jun. 11, 2010 (JP) 2010-133749
Jun. 11, 2010 (JP) 2010-133750
Jun. 11, 2010 (JP) 2010-133751
Jun. 11, 2010 (JP) 2010-133752
Jun. 11, 2010 (JP) 2010-133753
Jun. 11, 2010 (JP) 2010-133866

(51) Int. Cl. A61G 5/14

(52) U.S. Cl. CPC A61G 5/14
USPC 297/320; 297/313

(57) ABSTRACT

Provided is a chair in which the rear section of the seat can be raised with good lateral balance, in which the seat is stable, and that has a simple structure and a good appearance. The disclosed chair includes a seat (6) that is pivotally attached by means of a laterally-oriented pivot shaft (9) to a support base (5) supported by (a) leg(s), the rear section of the seat (6) being pivotable in the vertical direction. In said chair, an urging means (12) that urges the seat (6) upward is constructed so as to include: an elastic expanding-and-contracting component (13) that connects a portion of the support base (5) located below the pivot shaft (9) and a portion of the seat (6) located to the rear of the pivot shaft (9); and a pair of leaf-spring-like elastic warping components (14) provided on the right and left sides of the elastic expanding-and-contracting component (13).

### TECHNICAL FIELD

The present invention relates to a chair and in particular, a chair in which a seat is inclined upward and rearward in a position of non-use, the seat coming in contact with the buttocks of an occupant to pivot to a substantially horizontal position to assist the occupant in sitting down when he/she intends to sit down, the rear part of the seat rising to assist him/her in standing up when he/she intends to stand up.

### BACKGROUND OF THE INVENTION

Amongst these types of in chairs, for example, as described in Patent Literature 1, the seat pivots to a position of use where the seat is horizontal or is inclined rearward and downward with respect to lower parts of the chair, and a position of non-use where the seat is inclined rearward and upward. The backrest is pivotally mounted to pivot between an upright position and a rearward-inclining position. There is provided forcing means for forcing the seat toward the position of non-use and the backrest toward the upright position. There is also provided connecting means for holding the backrest in a substantially upright position while the seat pivots from the position of non-use to the position of use.

However, there are chairs wherein the seat and backrest are moved as above with a link mechanism and elastically-resisting means, for example, as described in Patent Literature 2.

Conventional compression springs include a compression coil spring and a cylinder type such as a gas spring.

In a reclining chair, the front end of laminated plate spring is fixed to the front end of the base mounted to the upper end of the leg. The plate spring is bent downward by a mounting plate of the seat, so that the backrest with the seat is leaned rearward under an elastically resisting force in Patent Literature 2, As forcing means for forcing the backrest forward, there is provided a gas spring between the rear end of the base and the lower end of the backrest in Patent Literature 4 and a rubber torsion spring within the base in Patent Literature 5.
Patent Literature 1: JP2010-104562A
Patent Literature 2: JP4379538B
Patent Literature 3: JP5-31965Y
Patent Literature 4: JP2005-211244A
Patent Literature 5: JP2006-87616A

### Problems to be Solve by the Invention

However, in the conventional chairs as described above, the rear or intermediate part of the seat is raised by the link mechanism, or elastically-resisting means, such as a torsion spring, is provided at a pivot shaft of the front part of the seat to force the seat toward forward-inclining posture thereby decreasing the stability of the rear part of the seat transversely of the chair. It is very difficult to raise the rear part of the seat in a suitable balance, and the link mechanism becomes more complicated and becomes larger to make the appearance worse.

In the conventional chairs as above, a number of link mechanisms must be disposed under the seat, and it is necessary to provide a large space for accommodating them. The link mechanisms are exposed to the outside to spoil the appearance as a chair.

In the chair in which an intermediate part of the seat is pushed up by the vertical link, it is necessary to provide a vertical large space under the seat.

The conventional compression coil spring as described above is bent in the same direction as compressive load. Thus, if the spring is used in those in which one of the two members relatively moves with deviation or rotation with respect to an axis of the spring, the spring is likely to buckle. Hence, it is very difficult to use the spring for multi-purposes.

Moreover, a cylinder-type compression spring is heavy and manufacturing cost is high.

In the reclining chair described in Patent Literature 3, a plate spring is used as forcing means for the backrest. In order to lean the backrest effectively, it is necessary to increase the length of the plate spring. Hence the base and mounting plate for the seat are lengthened.

When the backrest is leaned rearward, the whole plate spring is bent downward greatly, and it is necessary to provide a bending space under the plate spring. Hence the seat becomes higher that the base.

In the reclining chair described in Patent Literature 4, the gas spring is used as forcing means for the backrest, and the chair becomes heavier and expensive. Furthermore, the gas spring is mounted obliquely between the rear end of the base and the lower end of the backrest. Hence the heavy gas spring is exposed from behind the seat downward to spoil the appearance.

In the reclining chair described in Patent Literature 5, it is necessary to use the expensive and heavy torsion spring and various members for attaching it in the inside of the base. So the chair becomes heavier and more expensive.

In view of the foregoing disadvantages, the first object of the present invention is to provide a chair in which the rear part of the seat can be raised in a suitable balance, and the chair is more stable and more simple in structure to provide the chair with good appearance.

The second object of the present invention is to provide a chair in which forcing means for forcing the seat upward and a pushing rod for pushing the lower end of the backrest rearward when the seat pivots downward are disposed within a vertically small space under the seat without contacting each other in good balance transversely, its structure being simplified with good appearance.

The third object of the present invention is to provide a chair in which a force for moving the rear part of the seat upward can be increased, the seat being effectively assisted to stand up, the forcing means becoming smaller and more simple, thus reducing manufacturing costs.

The fourth object of the present invention is to provide a chair in which a versatile inexpensive simple compression spring is provided so that the chair is less expensive and more lightweight and provides better appearance.

### Means for Solving the Problems

According to the present invention, the problems are solved as below:

(1) According to the present invention, there is provided a chair comprising:

a base supported by a leg;

a seat pivotally mounted to the base via a transverse pivot shaft to allow a rear part of the seat to turn vertically; and

forcing means provided on the base to force the rear part behind the pivot shaft upward, characterized in that:

the forcing means comprises an elastically-extensible member that connects part of the base lower than the pivot shaft, to part of the seat behind the pivot shaft, and a pair of elastically-bendable members at each side of the elastically-extensible member, one end of each of the pair of elastically-bendable members being mounted to a lower surface of the seat, an intermediate part being elastically bent, the other end being mounted to part of the base lower than the pivot shaft.

The forcing means for forcing the seat upward comprises the elastically-extensible member and a pair of elastically-bendable member at each side of the elastically-extensible member. The rear part of the seat can be raised in a good balance, and the seat can be supported more stably.

The elastically-extensible member and elastically-bendable member can be disposed under the seat compactly thereby providing the chair with good appearance.

(2) In the item (1), a front end of the elastically-extensible member and a front end of a lower portion of each of the pair of elastically-bendable members are pivotally mounted to the base via a single shaft extending transversely of the chair.

The structure can be simplified and it can be simplified to connect the elastically-extensible member and elastically-bendable member to the base pivotally.

(3) In any one of the item (1) or (2), the pair of elastically-bendable members becomes wider rearward gradually in a plan view.

The rear part of the base the front end of which is pivotally mounted to the base can be supported more stably without wobbling transversely of the chair.

(4) In any one of the items (1) to (3), each of the pair of elastically-bendable members comprises a plate spring, one end of the plate spring being mounted to the lower surface of the seat, the other end being pivotally mounted to the base via a transverse single shaft with the front end of the elastically-extensible member.

The structure can be simplified and it can be simplified to connect the elastically-extensible member and elastically-bendable member to the base pivotally.

(5) In the item (4), an upper surface of a rear semicircular elastically-bendable portion of each of the elastically-bendable members is in contact with the lower surface of the seat so that the elastically-bendable portion of the elastically-bendable member moves rearward along the lower surface of the seat when the seat pivots downward.

When the seat turns downward, the elastically-bendable portion of the elastically-bendable member moves rearward along the lower surface of the seat thereby preventing stress from concentrating to the same point, improving durability and increasing a reaction force of the elastically-bendable member.

(6) In the item (4) or (5), the plate spring comprises an upper portion extending rearward from an upper mounting portion fixed to the seat; an elastically-bendable portion curved like a semicircle downward from a rear end of the upper portion so that an upper end of the elastically-bendable portion is in contact with the lower surface of the seat; a lower portion extending forward and downward from a lower end of the elastically-bendable portion; and a lower mounting portion mounted to the base at a front end of the lower portion, the plate spring being elastically bent in a U-shape and being open at a front end.

Such a structure increases a distance between part of the plate spring fixed to the seat and part mounted to the base, thereby increasing a moving range of the plate spring and simplifying the structure of the plate spring.

When the seat turns downward, the elastically-bendable portion is elastically deformed to move rearward gradually along the lower surface of the seat, so that the upward force of the seat by the plate spring becomes uniform wherever it is positioned within a turning range of the seat.

(7) In the item (6), a width between the lower portions gradually becomes smaller forward.

The structure increases a space about the lower portion of the plate spring, and the other parts can be placed within the space.

(8) In any one of the items (1) to (7), the elastically-extensible member comprises a gas spring.

The elastically-extensible member can be simplified to enable the chair to be produced at lower cost.

(9) In any one of the items (1) to (8), a lower part of the backrest is pivotally mounted to a rear part of the seat via a transverse pivot shaft so that the backrest pivots with respect to the seat between a standing position and a rearward-inclined position, the part of the base lower than the pivot shaft being connected to part of the backrest lower than the pivot shaft via an elastically-expandable pushing rod, the pushing rod pushing back a lower end of the backrest, when the seat pivots downward, to hold the backrest in the standing position, the pushing rod being elastically shrunk to enable the backrest to be inclined rearward with respect to the seat, a front end of the pushing rod being pivotally mounted to the base via a transverse shaft with the front end of the elastically-extensible member and the front end of the lower portion of the elastically-bendable member.

The forcing means and pushing rod can be simplified, and it can be simplified to connect the base to the elastically-extensible member, elastically-bendable member and pushing rod pivotally.

(10) In the item (9), the pushing rod comprises a pair of foot portions each of which is mounted at a front end to the base at each side of the elastically-extensible member; an elastically-bendable portion extending from a rear end of each of the pair of foot portions; and a connecting portion connecting the pair of foot portions to each other under the elastically-extensible member.

The forcing means for forcing the seat upward and pushing rod for pushing the lower end of the backrest rearward, when the seat turns downward, can be disposed within a vertically-small space under the seat without contacting each other in a transverse good balance.

Moreover, the forcing means and pushing rod can be disposed within the vertical small space under the seat thereby providing the chair with good appearance.

(11) In the item (9) or (10), the pushing rod comprises a compression spring for generating force to allow the ends to move away from each other, the ends having nonflexible hard portions, a pair of elastically-bendable portions being provided between the ends and compressed so that the portions are elastically bent outward or inward.

When the pushing rod is compressed longitudinally of the chair, the elastically-bendable portions are elastically bent inward or outward perpendicular to the compressing direction. So, even if the backrest relatively moves with respect to the base while it turns, both the elastically-bendable portions are elastically bent effectively thereby exhibiting spring force.

The compression spring is simpler in structure than a cylinder-type compression spring such as a gas spring thereby providing an inexpensive lightweight compression spring.

(12) In the item (11), both the elastically-bendable portions can be elastically bent in a direction perpendicular to a plate including the portions.

As the elasticity of the compression spring increases, it can be managed even if the lower end of the backrest moves a great distance away from the base.

(13) In the item (11) or (12), the elastically-bendable portions and connecting portion for connecting the ends thereof form a closed loop.

The elastically-bendable portions are elastically bent effectively thereby providing a strong spring force. It also provides enough strength and durability against repeated load.

(14) In any one of the items (11) to (13), the elastically-bendable portion has a substantially circular cross-section.

The elastically-bendable portion can be elastically deformed effectively in all directions including inward and outward directions.

(15) In any one of the items (11) to (13), both of the elastically-bendable portions have a rectangular cross-section which has a long side along the plane including these portions.

The elastically-bendable portions, as they are likely to be elastically bent in a direction perpendicular to the plane including these portions, can handle cases even in which the lower end of the backrest moves a great distance away from the base.

(16) In any one of the items (11) to (15), the elastically-bendable portions and hard portions are integrally molded out of synthetic resin.

The inexpensive lightweight compression spring can be molded out of synthetic resin easily. Even if it has a closed loop, it can be molded by a die easily.

(17) In a chair that comprises a base supported by a leg; a seat that is pivotally mounted to the base via a transverse pivot shaft to turn between a position of use where the seat is horizontal or is inclined rearward and downward and an position of non-use where the seat is inclined rearward and upward; a backrest a lower part of which is pivotally mounted to a rear part of the seat via a transverse pivot shaft to turn between a standing position and a rearward-inclined position; forcing means that forces part of the seat behind the pivot shaft upward; an elastically-extendable pushing rod that connects part of the base lower than the pivot shaft to part of the backrest lower than the pivot shaft to press the lower end of the backrest when the seat turns downward, to hold the backrest in the standing position, the pushing rod being elastically deformed to enable the backrest to be inclined rearward with respect to the seat, the forcing means comprises a pair of elastically-bendable members one end of which is fixed to the lower surface of the seat and the other end is mounted part of the base lower than the pivot shaft so that an intermediate portion is formed like U and elastically bent, the pushing rod being disposed between the elastically-bendable members.

The forcing means for forcing the seat upward and pushing rod for pushing the lower end of the backrest downward when the seat turns downward can be disposed within a vertical small space under the seat without contacting each other in a transverse good balance.

Furthermore, because the forcing means and pushing rod are disposed within the small space under the seat, the chair provides good appearance.

(18) In the item (17), the compression spring is disposed so that the elastically-bendable portions can be elastically bent transversely of the chair between the base and the seat.

The elastically-bendable portions are elastically bent transversely of the chair, thereby avoiding necessity of vertical bending space for the compression spring, so that the seat can be set to be lower in the position of use.

(19) In the item (18), the front and rear hard portions that extend transversely of the chair are pivotally attached to the base and backrest respectively via shafts which go through the hard portions.

The hard portions are wide transversely making the compression spring to the base and backrest more stable and enabling the elastically-bendable portions to be elastically deformed effectively between the base and seat transversely of the chair.

The front and rear ends of the compression spring can be easily connected to the base and backrest with the transverse shaft.

(20) In the item (18) or (19), an elongate hole is formed at the rear end of a longitudinal link the front end of which is pivotally mounted to the lower surface of the seat via a transverse shaft. A transverse shaft for connecting the rear end of the compression spring with the backrest slides within the elongate hole to limit turning of the backrest with respect to the seat.

The maximum rearward inclination of the backrest is limited, and the elastically-bendable portions of the compression spring are prevented from being elastically deformed excessively thereby improving durability of the compression spring.

(21) In a chair that comprises a base supported by a leg; a seat that is pivotally mounted to the base via a transverse pivot shaft to turn between a position of use where the seat is horizontal or is inclined rearward and downward and an position of non-use where the seat is inclined rearward and upward; a backrest a lower part of which is pivotally mounted to a rear part of the seat via a transverse pivot shaft to turn between a standing position and a rearward-inclined position; forcing means that forces part of the seat behind the pivot shaft upward; an elastically-extendable pushing rod that connects part of the base lower than the pivot shaft to part of the backrest lower than the pivot shaft to press the lower end of the backrest when the seat turns downward, to hold the backrest in the standing position, the pushing rod being elastically deformed to enable the backrest to be inclined rearward with respect to the seat, the forcing means comprises a longitudinal elastically-extensible member the end of which is connected to part of the base lower than the pivot shaft and part of the seat behind the pivot shaft, the pushing rod comprising a pair of foot portions each of which is mounted at the front end to the base at each side of the elastically-extensible member; elastically-bendable portions that extend from the rear end of the foot portions; and a connecting portion that connects the foot portions to each other below the elastically-extensible member.

The forcing means for forcing the seat upward and pushing rod for pushing the lower end of the backrest rearward when the seat turns downward can be disposed within a vertical small space under the seat without contacting each other in a transverse good balance.

Furthermore, the forcing means and pushing rod can be disposed within the vertical small space under the seat thereby providing the chair with good appearance.

(22) In a chair in which a seat is pivotally mounted to a base supported by a leg via a transverse pivot shaft so that a rear part of the seat turns vertically, forcing means being provided in the base to force part behind a pivot shaft of the seat upward, the forcing means comprises a plate spring one end of which is mounted to the lower surface of the seat, intermediate portions being elastically bent, the other end being mounted to part of the base lower than the pivot shaft of the base.

The part of the lower surface of the seat away from the pivot shaft can be raised thereby increasing a force for raising the rear part of the seat. Thus, the seat can be raised more easily. The plate spring is turned back in the middle and becomes smaller. The plate spring is used as forcing means thereby simplifying the structure of the forcing means and reducing the costs.

(23) In a compression spring in which force is produced so that the ends may move away from each other, nonflexible hard portions are provided on the ends, a compressive force being applied to an intermediate portion between the hard portions to enable them to be elastically deformed outward or inward.

When the longitudinal compressive force is applied to the compression spring between the ends, the elastically-bendable portions are elastically deformed inward or outward perpendicular to a compressing direction. Thus, even if one of the two members turns relatively with respect to the other, both the elastically-bendable portions are elastically bent to provide a spring force and provide high versatility.

Moreover, the compression spring is simpler in structure than a cylinder-type compression spring such as a gas spring thereby providing an inexpensive lightweight compression spring.

(24) In a chair in which a seat is supported by a base supported by a leg, the lower part of the backrest being pivotally mounted to the rear part of the base or seat via a transverse shaft so that the backrest can be inclined rearward, the part of the backrest lower than shaft and the base are connected via hard portions at the ends of the compression spring in the item 23, so that the elastically-bendable portions of the compression spring are elastically shrunk to enable the backrest to be inclined rearward.

As it is not necessary to use expensive complicated backrest-forcing means such as a gas spring or a rubber torsion spring, an inexpensive lightweight chair can be provided.

A heavy gas spring is not exposed to the outside thereby providing a chair with good appearance.

(25) In a chair that comprises a base supported by a leg; a seat pivotally mounted to the base via a transverse pivot shaft to enable the rear part to turn vertically; and forcing means mounted in the base to force part of the seat behind the pivot shaft, part of the base lower than the picot shaft and part of the backrest lower than pivot shaft are connected to each other with hard portion of the ends of the compression spring in claim 23, thereby pushing back the lower end of the backrest of the compression spring to hold the backrest in a standing position, the elastically-bendable portions of the compression spring being elastically shrunk to enable the backrest to be inclined rearward with respect to the seat

With exhibiting the advantage similar to those in the item (24), while the seat turns from an upward-and-rearward inclined position to a rearward-and-downward-inclined position, the backrest is held in the standing position by force of the compression spring, so that the backrest is unlikely to accidentally fall rearward, when the occupant intends to sit down, and, thus, is safe.

### BRIEF DESCRIPTION OF THE DRAWINGS

FIG. 1 is a front elevational view of one embodiment of a chair according to the present invention in a position of non-use.

FIG. 2 is a side elevational view thereof.

FIG. 3 is a side elevational view in a position of use.

FIG. 4 is a side elevational view in the position of use when the backrest is inclined rearward.

FIG. 5 is a central vertical sectional side view of the chair in the position of non-use without cushion material.

FIG. 6 is a partially exploded perspective view of a base and a member attached to the base.

FIG. 7 is a top plan view of a plate spring.

FIG. 8 is a side elevational view of the plate spring.

FIG. 9 is a top plan view of a compression spring.

FIG. 10 is a side elevational view of the compression spring.

FIG. 11 is a sectional view taken along the line XI-XI in FIG. 9.

FIG. 12 is an exploded perspective view of the backrest.

FIG. 13 is an enlarged perspective view of the main part of the structure for connecting the backrest to a seat plate.

FIG. 14 is a perspective view of a concave portion, an engagement hole and a stopper of the seat plate.

FIG. 15 is a sectional view taken along the line XV-XV in FIG. 2.

FIG. 16 is a vertical sectional side view showing the positional relationship between a back frame and the set plate in the position of non-use.

FIG. 17 is a vertical sectional side view showing the positional relationship between the back frame and the seat plate when the backrest is inclined rearward.

FIG. 18 is an exploded perspective view showing an engagement concave portion and an engagement member of an intermediate connecting rod.

FIG. 19 is an enlarged sectional view taken along the line XIX-XIX in FIG. 1.

FIG. 20 is an enlarged sectional view taken along the line XX-XX in FIG. 1.

FIG. 21 is an enlarged sectional view taken along the line XXI-XXI in FIG. 1.

FIG. 22 is an enlarged top plan view showing a variation of a compression spring.

FIG. 23 is an enlarged side view thereof.

FIG. 24 is an enlarged vertical sectional view taken along the line XXIV-XXIV in FIG. 22.

FIG. 25 is a side elevational view of a chair having the compression spring in FIG. 22.

FIG. 26 is an enlarged central vertical sectional side view of the main part of a chair having another variation of a compression spring before sitting.

FIG. 27 is a perspective view of a connecting portion in which the compression spring is connected to the lower portion of a seat via a link.

FIG. 28 is a side elevational view showing a variation in which the compression spring is attached in another chair.

FIG. 29 is a vertical sectional side view of a variation where a plate spring is integrally formed with a seat.

### BEST MODE FOR CARRYING OUT THE INVENTION

One embodiment of the present invention will be described with respect to appended drawings.

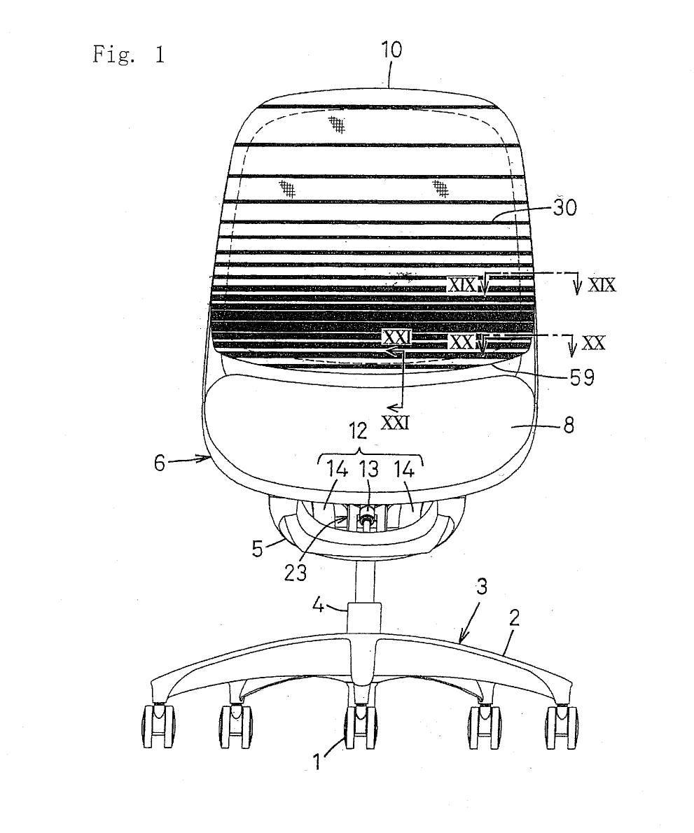

In FIGS. 1-4, a chair comprises a leg 3 having five radially-disposed leg rods 2 each of which has a caster 1 at the distal end. A telescopic leg post 4 having a gas spring (not shown) stands at the center of the leg 3. To the upper end of the leg post 4, a base 5 is fixed at the rear end. The base 5, leg post 4 and leg 3 may be integrally formed.

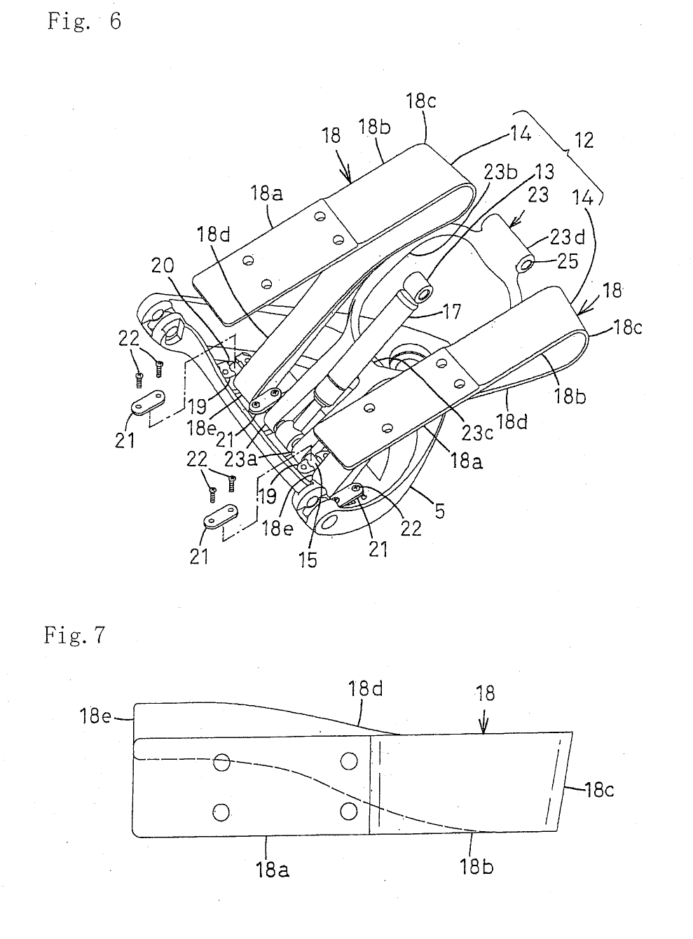

In FIG. 6, the base 5 comprises a triangular shallow dish expanding forward in a plan view and is inclined upward and forward in a side view. In FIG. 1, the base 5 is U-shaped in a front view. In order to mount a member to the base 5, the member or a tool can be easily put in not only from the side and back but also from the front.

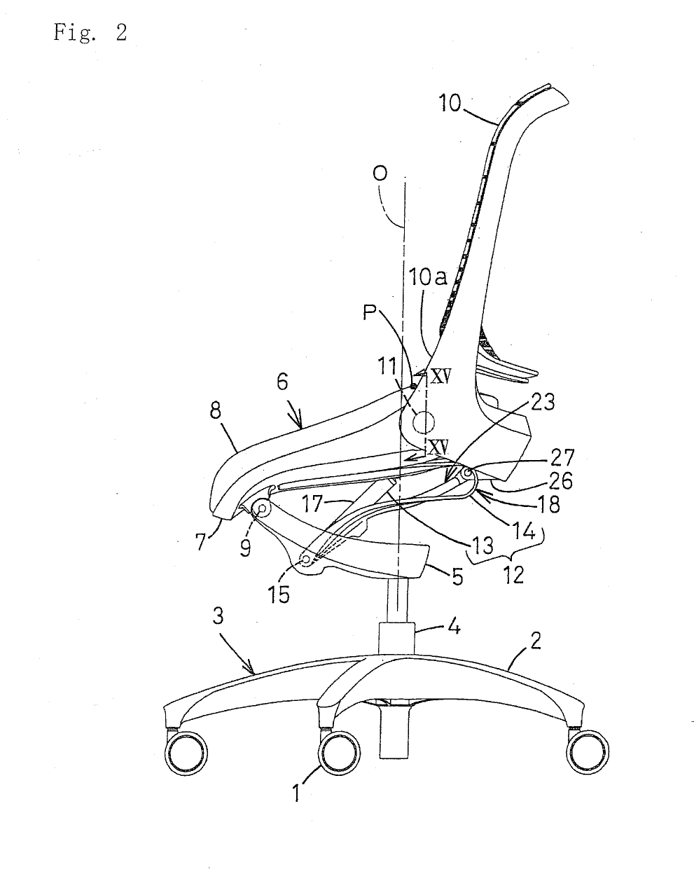

The seat 6 comprises a synthetic resin seat plate 7 and cushion material 8 mounted on the upper surface of the seat plate 7 so that an occupant sits on the cushion material. The front end of the seat plate 7 is pivotally mounted to the front end of the base 5 via a pivot shaft 9. The seat 6 can pivot about the pivot shaft 9 between position of non-use where the seat 6 is inclined rearward and upward before sitting in FIG. 2 and a position of use where the seat 6 is horizontal or inclined rearward and downward when the occupant sits. The seat 6 may preferably be pivoted within about 15 degrees.

The seat 6 is forced upward toward the position of non-use anytime by forcing means later described.

In FIG. 2, when the seat 6 is in the position of non-use, a first-contact portion P with which the occupant first comes in contact first is positioned behind a center line O of the leg post 4.

The first-contact portion P may be preferably the same as a stable support portion for supporting the hipbone or the buttocks when the occupant sits at a suitable posture.

The first-contact portion P is positioned behind the center line O of the leg post 4 when the seat 6 is in the position of non-use, so that the chair unlikely moves rearward when the occupant sits down on the seat 6 in the position of non-use, thus allowing the buttocks of the occupant to come in contact with the first-contact portion P of the seat 6.

After the buttocks of the occupant come in contact with the first-contact portion P of the seat 6, the seat 6 turns to the position of use with the buttocks of the occupant against the force of the forcing means 12 and guides the buttocks of the occupant to a stable-support point to allow the occupant to readily take his or her suitable seating posture. The occupant exerts load rearward of the leg post 6, so that the buttocks of the occupant can be supported stably by the rear part of the seat 6.

As a rearward and upward angle of inclination in the position of non-use becomes larger, the first-contact portion P moves forward to becomes closer to or becomes positioned in front of the leg post 4. The rearward and upward angle of inclination of the seat 6 in the position of non-use may preferably be defined so that the first-contact portion P is positioned behind the center line O of the leg post 4.

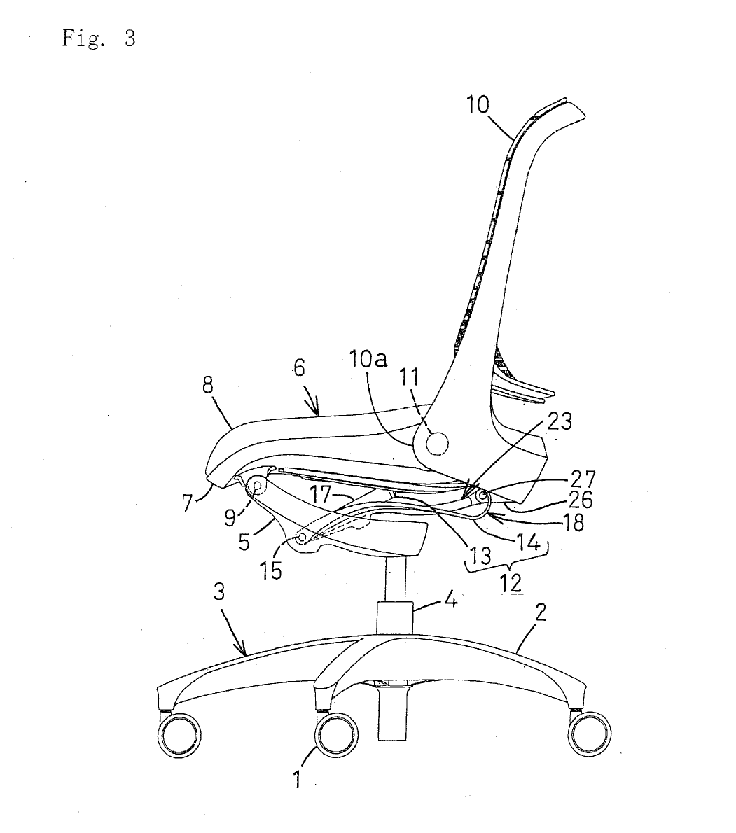

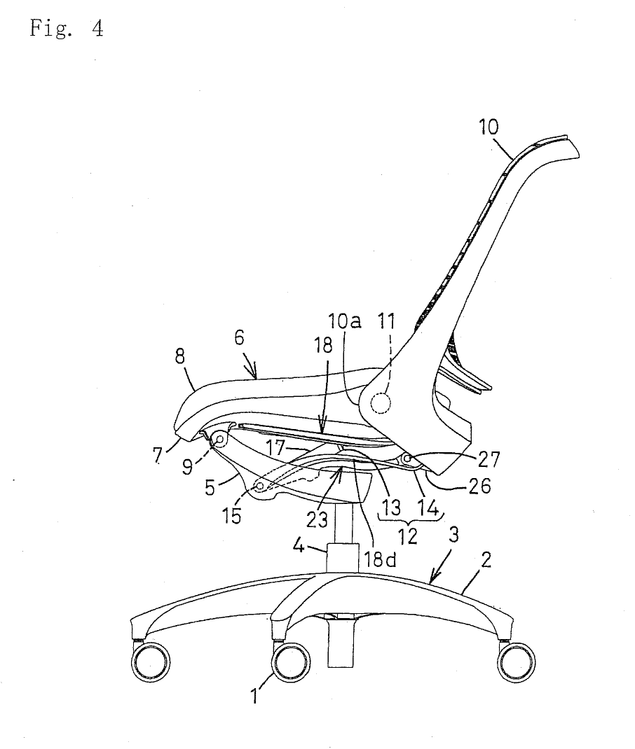

The front part of an extension 10a which extends from each side of the lower part of a backrest 10 is pivotally attached via a pivot shaft 11 on each side of the rear part of the seat plate 7 so that the front part is positioned behind the center line O of the leg post 4. The backrest 10 can pivot about a pivot shaft 11 between a substantially upright position in FIGS. 2 and 3 and a rearward-inclined position in FIG. 4. The structure of the backrest 10 and pivoted parts thereof do not directly relate to the present invention, and the illustration and description thereof are omitted.

The forcing means 12 for forcing the rear part of the seat 6 upward is provided on the base 5.

The forcing means 12 comprises an elastically-extensible member 13 which connects part of the base 5 lower than the pivot shaft 9 to part of the seat 6 behind the pivot shaft 9; and a pair of elastically-bendable members 14,14 in which the front upper end is fixed to the lower surface of the seat 6, each of the pair of elastically-bendable members 14,14 having a U shape in a side view, the front lower end being attached to part of the base lower than the pivot shaft 9.

In FIGS. 2, 5 and 6, the front end of the elastically-extensible member 13 is pivotally mounted to the base 5 via a transverse shaft 15, and the rear end comprises a gas spring 17 having no locking function and pivotally mounted to the middle of the lower surface of the seat 6. A gas spring which has locking function, a compression spring, an oil damper or an air damper may be used.

For a locking gas spring, unlocking means may be provided on part of an armrest (not shown).

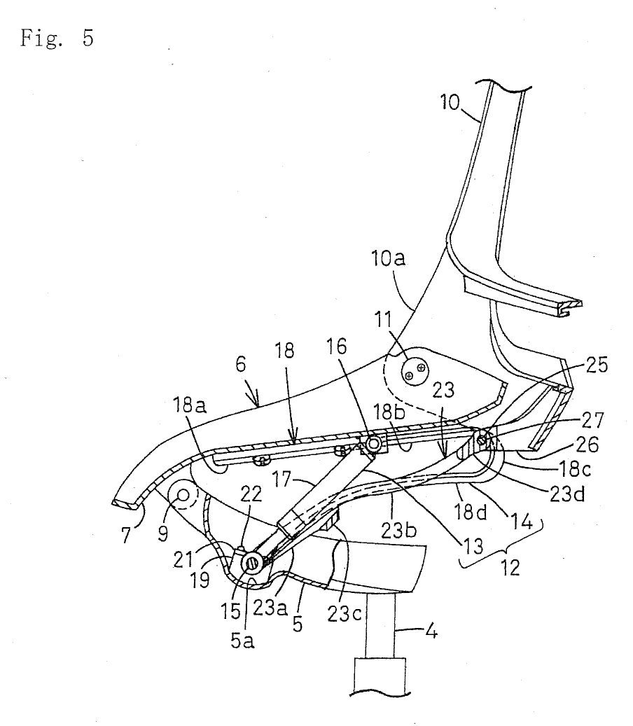

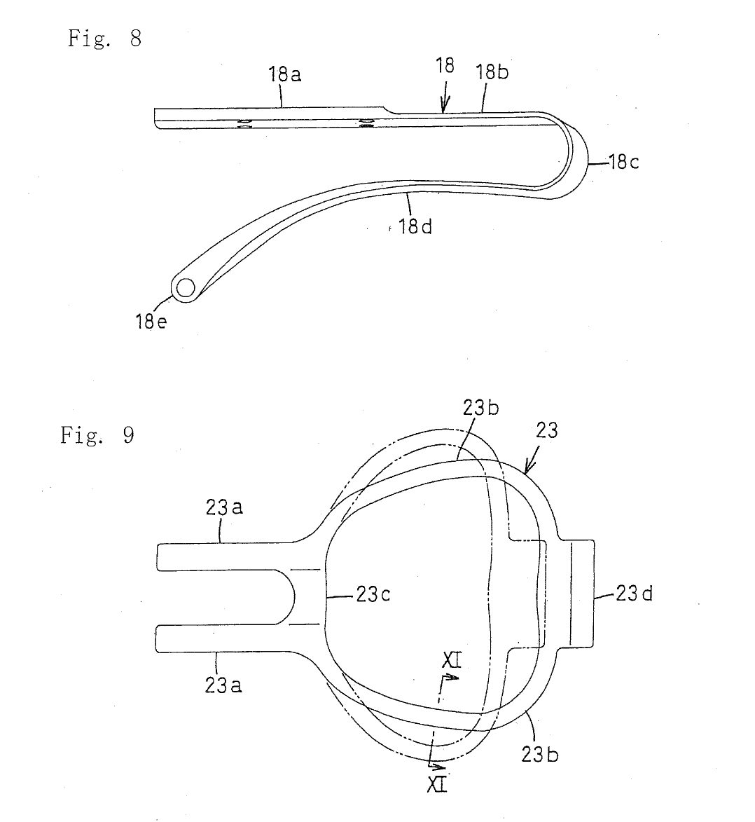

In FIGS. 5-8, the elastically-bendable members 14 have a pair of plate springs 18,18 made of synthetic resin, comprising a rectangular upper mounting portion 18a mounted with screws to the front sides of the lower surface of the seat 6; an upper portion 18b which extends rearward from the upper mounting portion 18a; an elastically-bendable portion 18c which curves like a semicircle at the rear end of the upper portion 18b; a lower portion 18d extending forward and downward from the lower end of the elastically-bendable portion 18c; and a lower mounting portion 18e positioned at the front end of the lower portion 18d and fixed to the base 5. The plate springs 18 are made of metal.

The width between the lower portions 18d and 18d of the plate spring 18 gradually becomes smaller forward in order to accommodate the gas spring 17 and a pushing rod 23 (later described) and avoid them within a small space under the seat 6.

In FIG. 6, the plate springs 18,18 may preferably be disposed so that a distance between the lower portions 18d and 18d becomes larger rearward gradually in a plan view. Furthermore, a distance between the upper portions 18b and 18b may preferably get larger rearward gradually. Thus, the rear part of the seat 6 can be supported stably.

The lower mounting portions 18e,18e of the plate springs 18,18 are pivotally attached to the side ends of the shaft 15.

The shaft 15 is fixed on the upper surface of the base 5 as below. In FIGS. 5 and 6, a concave portion 5a is formed on the bottom surface lower than the pivot shaft 9 of the base 5. In the concave portion 5a, a plurality of projections 19 is provided transversely. A U-shaped groove 20 is formed on the upper surface of the projection 19. By mounting a holding metal tool 21 with screws 22,22 on the upper surface of each of the projections 19, the shaft 15 is fixed on the upper surface of the front end of the base 5 not to turn. Alternatively, the shaft 15 may turn.

The forcing means 12 comprises the elastically-extensible member 13; and a pair of elastically-bendable members 14 at each side of the elastically-bendable member 13. Thus, the rear part of the seat 6 can be pulled up in a good balance and the seat 6 can be supported stably.

The elastically-extensible member 13 and the elastically-bendable member 14 are small and can be disposed under the seat 7 compactly thereby providing the chair with good appearance.

As mentioned above, with the gas spring 17 as elastically-extensible member 13 and the plate spring 18 as elastically-bendable member 14, the structure can be simplified and manufactured at low cost.

The front end of the elastically-extensible member 13 and front lower ends of the elastically-bendable members 14 are pivotally mounted to the base 5 about the same transverse shaft 15, so that the structure can be simplified, and the elastic expanding member 13 and elastically-bendable member 14 can pivotally be mounted to the base 5 more easily.

The upper surface of the elastically-bendable portion 18c of the plate spring 18 is in contact with the lower surface of the seat 6. When the seat 6 turns downward, the distance between the upper mounting portion 18a and the lower mounting portion 18e reduces, so that the lower portion 18d is pushed rearward and upward, and the plate spring 18 is elastically deformed so that the elastically-bendable portion 18c moves rearward along the lower surface of the seat 6.

The elastic deformation of the plate spring 18 prevents stress from concentrating to the same point, thereby improving durability of the plate spring 18 and increasing the reaction force of the plate spring 18.

Accordingly, the reaction force of the plate spring 18 increases, as the seat 6 turns downward.

Parts of the base 5 lower than the pivot shaft 9 and parts of the backrest 10 lower than the pivot shaft 11 are connected to each other by an elastically-extensible pushing rod 23.

When the seat 6 turns downward from the position of non-use to the position of use, the lower end of the backrest 10 is pushed rearward by the pushing rod 23, so that the backrest 10 is kept in the upright position. Furthermore, the pushing rod 23 is elastically shrunk, so that the backrest 10 can be inclined rearward against elastically restoring force of the pushing rod 23 as shown in FIG. 4.

In FIG. 6 and FIGS. 9-11, at each side of the gas spring 17 having the elastically-extensible member 13 at the front end, the pushing rod 23 comprises a compression spring comprising a pair of nonflexible hard foot portions 23a,23a pivotally attached to the base 5 via the transverse shaft 15; a pair of circular-sectioned elastically-bendable portions 23b,23b at the rear ends of the foot portions 23b,23b; a connecting portion 23c connecting the rear end of the foot portion 23a to the rear end of the foot portion 23a; and a nonflexible hard connecting portion 23d connecting the rear end of the elastically-bendable portion 23b to the rear end of the elastically-bendable portion 23b.

The connecting portion 23c is concave in the middle not to contact the lower surface of the gas spring 17. The pushing rod 23 may preferably be made of hard synthetic resin such as polyamide.

There is formed an axial hole 24 through which the shaft 15 is put, at the front ends of the foot portions 23a.23a.

In the wider connecting portion 23d at the rear end, there is formed an axial hole 25 through which a axial pin 27 for mounting the connecting portion 23d pivotally to a pair of bearing portions 26 projecting in the middle of the lower end of the backrest 10 is put.

The elastically-bendable portions 23b,23b are curved transversely outward and its section is circular.

The elastically-bendable portions 23b,23b, the connecting portion 23c and the connecting portion 23d constitute a circular closed loop.

The elastically-bendable portions 23b,23b of the pushing rod 23 are arranged side by side to allow the base 5 to be connected to the backrest 10, so that the elastically-bendable portions 23b,23b are elastically bent to expand outward as shown by two dotted lines in FIG. 9. Contrary to the above, the elastically-bendable portions 23b,23b are bent and bent inward transversely of the chair.

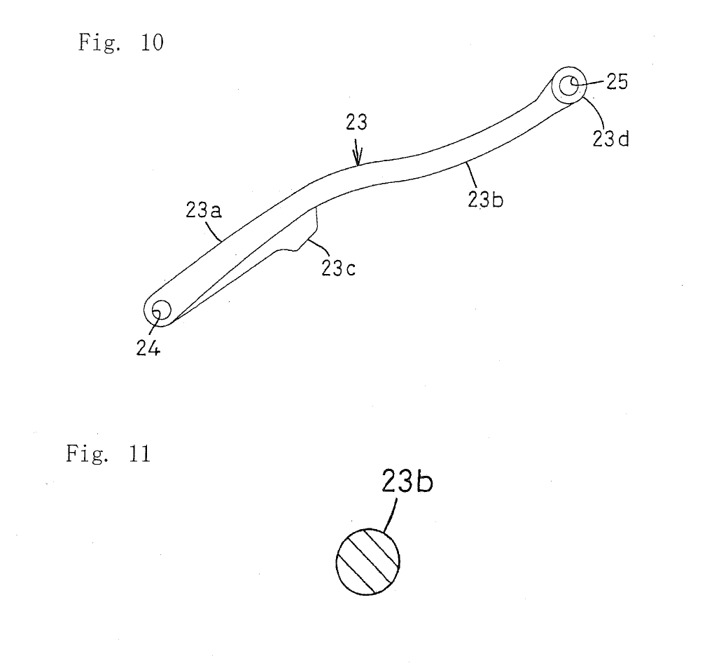

In FIG. 10, the elastically-bendable portions 23b,23b are slightly curved in the middle downward in a side view. When compressive load is exerted to the elastically-bendable portions 23b longitudinally, the middle can be elastically deformed downward perpendicular to a plane including the elastically-bendable portion 23b. Alternatively, the elastically-bendable portion 23b may be curved upward contrary to the above.

When a longitudinal compressive force is applied to the compression spring used as the pushing rod 23 between the front and rear ends, the elastically-bendable portions 23b,23b are elastically deformed in a direction perpendicular to a compressing direction. Even if one of the base 5 and the backrest 10 turns to move relatively like the backrest 10 as above, the elastically-bendable portions 23b,23b are effectively bent to exhibit spring force to make the pushing rod 23 more versatile.

Compared with a cylinder-type compression spring such as a gas spring, as the structure is more simple, a stable lightweight compression spring can be provided.

Furthermore, with the elastically-bendable portions 23b,23b, connecting portion 23c and connecting portion 23d for connecting them, a circular or non-circular closed loop is formed, and the elastically-bendable portion 23b is effectively bent to provide a strong spring force. Against repeated load, sufficient strength and durability are obtained. Moreover, the elastically-bendable portion 23b has a substantially circular section and can be elastically deformed effectively in any directions.

As the elastically-bendable portion 23b can be elastically deformed in a direction perpendicular to a plane including this portion the moving distance is relatively large between the front and rear ends, and the backrest 10 can be inclined rearward to a large extent.

The compression spring as above is attached as the pushing rod 23 between the base 5 and the backrest 10 in the foregoing embodiment of a chair. When the backrest is inclined rearward, the two elastically-bendable portions 23b,23b are elastically deformed transversely, so it is not necessary to provide a vertical bending space for the pushing rod 23 between the base 5 and the seat 6, thereby reducing the height of the seat 6 in the position of use.

The compression spring as the pushing rod is more simple and less expensive than backrest-forcing means such as a gas spring and a rubber torsion spring thereby making a chair more lightweight and reducing the costs.

Furthermore, in the pushing rod 23, the front foot portions 23a and rear wider connecting portion 23d are pivotally attached to the base 5 and backrest 10 via the transverse shaft 15 and axial pin 27 to achieve stable elastic deformation.

The front ends of the foot potions 23a,23a of the pushing rod 23 are pivotally mounted to the base 5 via the same transverse shaft 15 with the front end of the gas spring 17 as the elastic expanding member 13 and lower mounting portions 18e,18e of the plate springs 18,18 as the elastically-bendable member 14, thereby simplifying the structure further and facilitating the mounting of the elastically-extensible member 13, elastically-bendable member 14 and pushing rod 23 to the base 5.

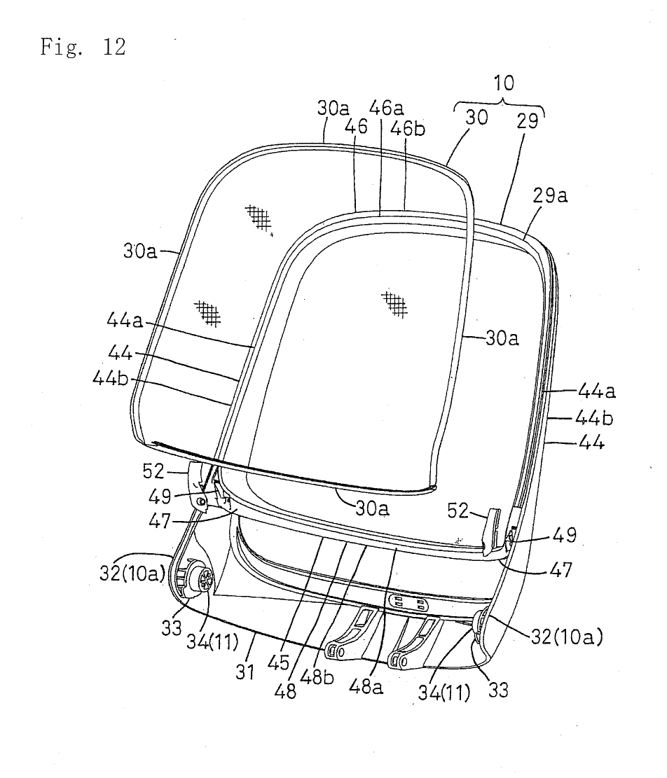

Then, the connection between the backrest 10 and the seat 6 will be described. In FIG. 12, the backrest 10 comprises a closed-loop back frame 29 and a stretched material 30 stretched over the surface 29a of the back frame 29. The lower frame portion 31 of the back frame 29 is bent to be concave, and a forward projection 32 which forms the extending portion 10a is provided at each side of the lower frame portion 31.

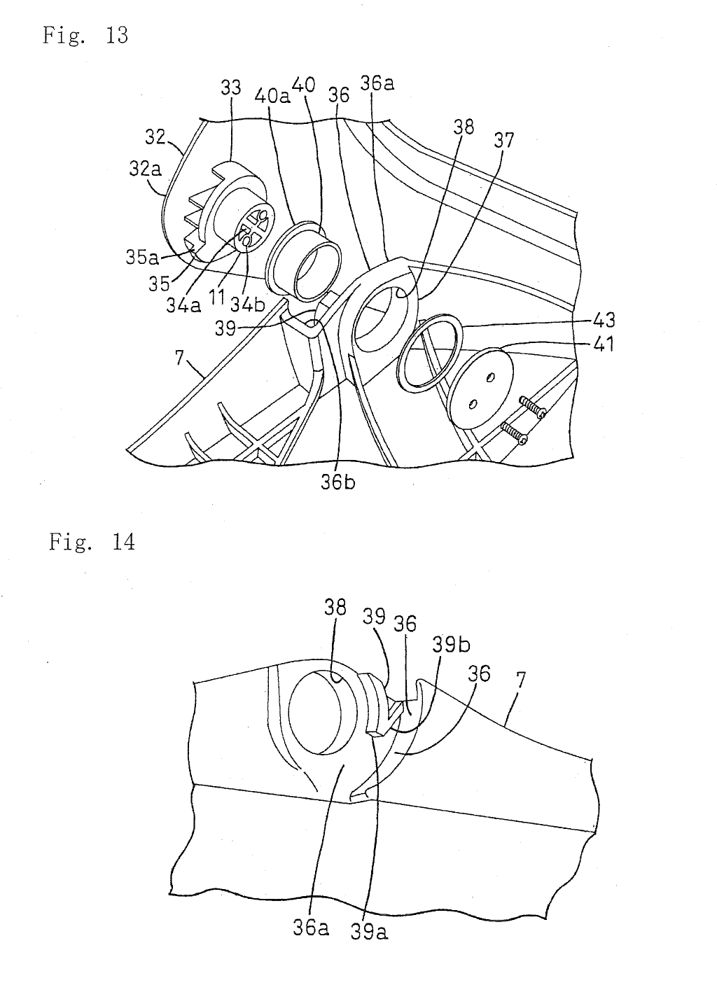

On the inner surface of each of the forward projections 32, there is provided a relatively short projecting shaft 34 extending inward of the back frame 29 on a support 33. The projecting shaft 34 is smaller in diameter than the support 33. In FIG. 13, in the projecting shaft 34, there are provided a cross reinforcement rib 11a, and two threaded bores 11b,11b. An outward projection 35 is provided on the outer circumference of the support 33. At one end of the outer circumference of the outward projection 35, a flat surface 35a extends toward the center of the support 33.

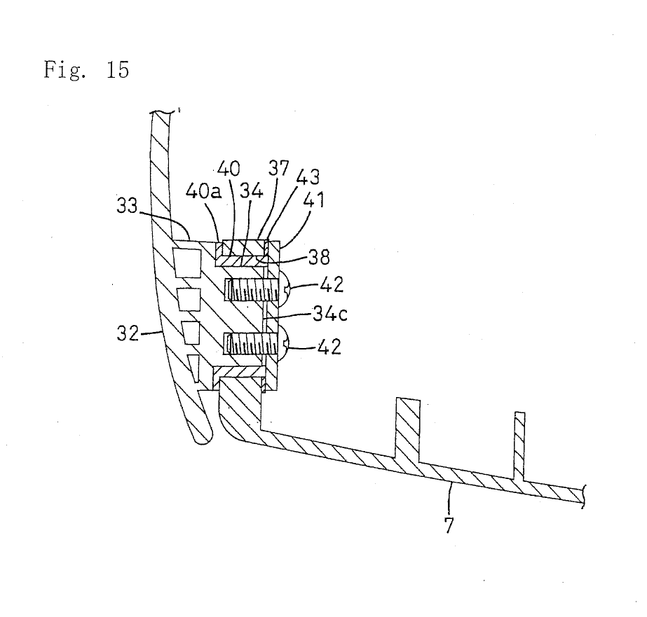

On the rear side of the seat plate 7, an inwardly-recessed step 36 is provided. A thick portion 37 is provided on a side surface 36a of the step 36, and an engagement hole 38 is formed in the thick portion 37. A front edge 32a of the forward projection 32 of the back frame 29 and a front face 36b of the step 36 are curved at the same curvature of radius in FIG. 14.

In FIG. 14, on the side surface 36a of the step 36, there is provided an arcuate stopper 39 which is concentric with and is larger in diameter than the engagement hole 38. At one end of the stopper 39, there is formed a flat surface 39a and a reinforcing rib 39b extending perpendicular to the flat surface 39a or tangentially to the stopper 39.

In FIG. 13, in order to connect the backrest 10 to the seat 6, a collar-having sleeve 40 engages on the outer circumference of the projecting shaft 34 so that a collar 40a surrounds the sleeve 40, and the forward projection 32 of the backrest 10 is put in the inward-recessed step 36 of the seat plate 7. In FIG. 15, the projecting shaft 34 engages in the engagement hole 38 with the collar-having sleeve 40 from the outside of the seat plate 7.

Then, to an end face 34c of the projecting shaft 34 is mounted a disc-shaped larger-diameter holding member 41 with a screw 42 from the inside of the seat plate 7. In this case, a sliding member 43 may be preferably held between the thick potion 37 and the holding member 41. Thus, the holding member 41 is rotatably mounted to the thick portion 37 of the seat plate 7.

Furthermore, when the forward projection 32 of the back frame 29 is disposed in the inward-recessed step 36 of the seat plate 7, the front edge 32a of the forward projection 32 is fitted with the front face 36 of the inward-recessed step 36 with a slight space.

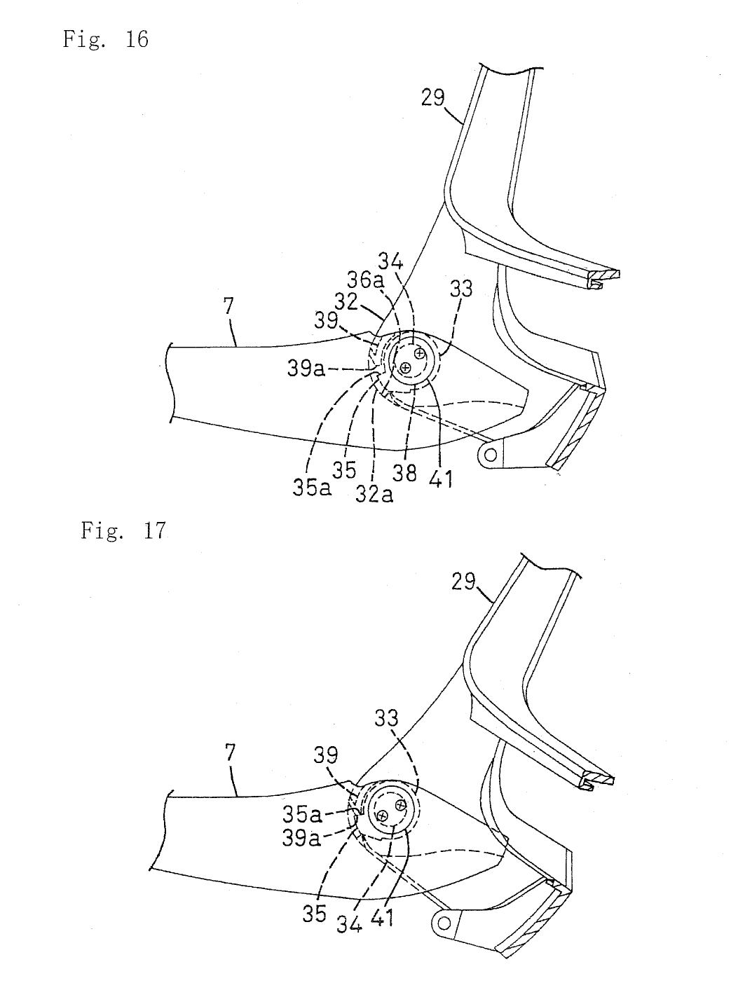

When a rearward load is not exerted to the backrest, the flat surface 35a of the outward projection 35 is spaced from the flat surface 39a of the stopper 39 of the seat plate 7 in FIG. 16.

When the occupant exerts rearward load on the backrest 10 in FIG. 17, the back frame 29 turns rearward about the projecting shaft 34. When the back frame 29 turns to the maximum allowable rotation angle, the flat surface 35a of the outward projection 35 of the back frame 29 comes in contact with the flat surface 39a of the stopper 39 of the seat plate 7, so that the backrest 10 stops turning.

The impact load for allowing the outward projection 35 to contact the stopper 39 acts in the same direction as the reinforcing rib 39, thereby improving load resistance of the stopper, so that the stopper 39 is prevented from breakage.

After the back frame 29 is connected with the seat plate 7, the seat plate 7 is covered with the cushion material 8 so that a portion connecting the projecting shaft 34 to the engagement hole 38 may be covered in FIG. 1.

Then, the structure of stretched material 30 over the back frame 29 will be described. In FIG. 12, an intermediate connecting rod 45 is provided between the right and left side frame portions 44 and 44 of the closed-loop back frame 29 of the backrest 10. The intermediate connecting rod 45 is provided between an upper frame portion 46 and a lower frame portion 31 of the back frame 29 at a position corresponding to the lower back of the occupant, in this embodiment, at a position relatively close to the lower frame portion 31, which is vertically long and relatively thin.

The intermediate connecting rod 45 is connected to the inner side of the right and left side frame portions 44, and comprises connecting portions 47,47 curved rearward and a straight portion 48 between the right and left connecting portions 47 and 47. The straight portion 48 projects rearward from the side frame portions 41,41.

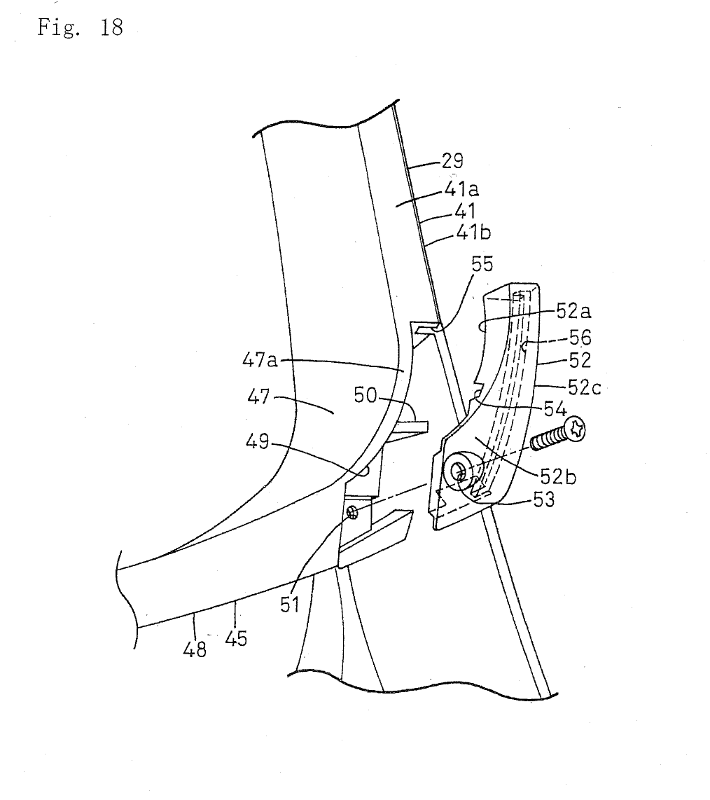

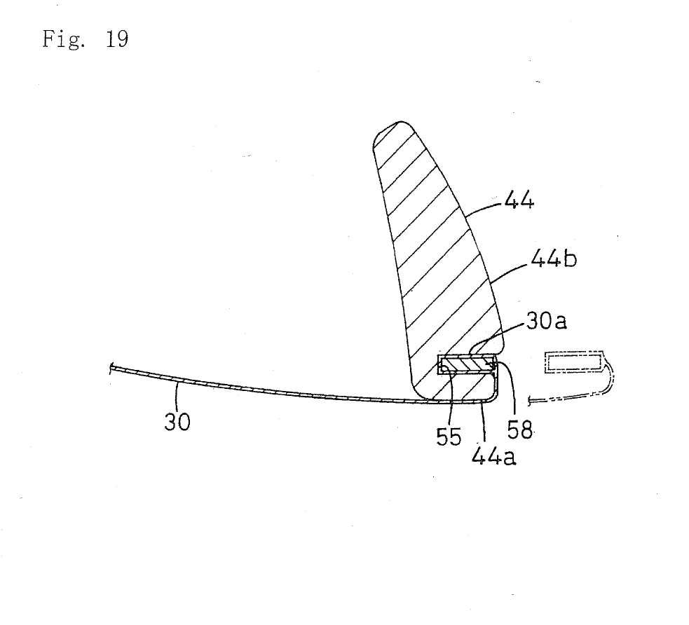

On the surface 47a of each of the connecting portions 47,47 is formed an engagement recess 49. In FIG. 18, in the engagement recess 49, a positioning rib 50 extends transversely and a threaded bore 51 is formed.

An engagement member 52 engages in the engagement recess 49. At one end of the engagement member 52, there is formed a screw-engagement bore 53. On a bottom surface 52a of the engagement member 52, there is formed a positioning groove 54 in which the positioning rib 50 of the engagement recess 49 engages.

In FIG. 19, the right and left side frame portions 44 are formed to be elongate longitudinally of the chair and to become thicker gradually from the rear end to the front end. On the outer circumferential surface 44b close to the front surface 44a and higher than the intermediate connecting rod 45 of the side frame portions 44, there is formed a vertically-extending groove 55 which is open outward. The groove 55 is also formed on the outer circumferential surface of the upper frame portion 46 close to the front surface 46a. The longitudinal end of the groove 55 of the side frame portions 44 is open in an engagement recess 49 of the connecting portion 48 of the intermediate connecting rod 45 in FIG. 18.

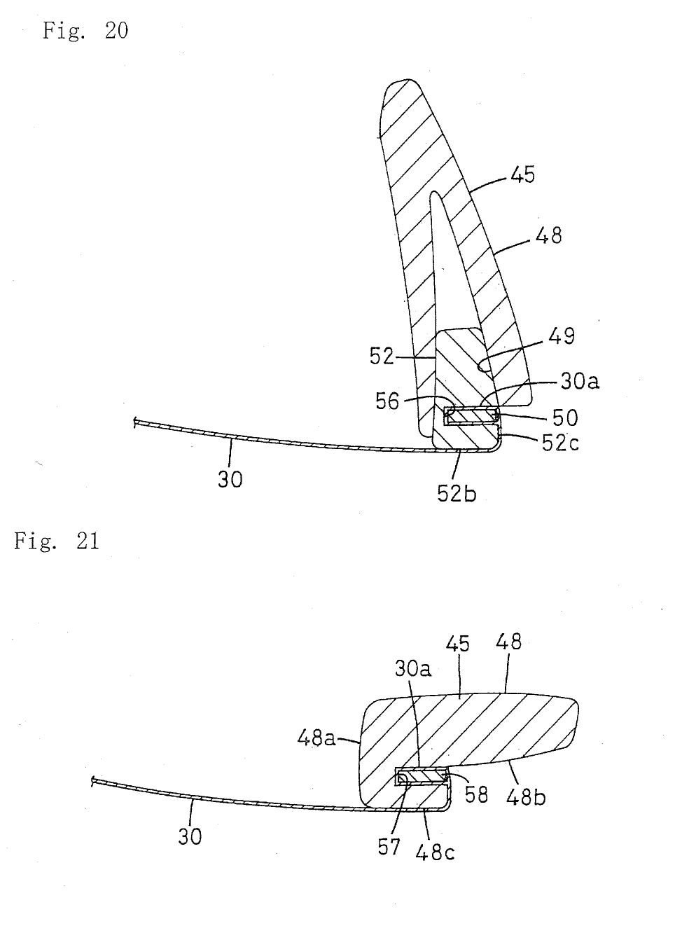

In FIG. 20, on an outer circumferential surface 52c close to the front surface 52b in FIG. 18 of the engagement member 52 engaged in the engagement recess 49, there is formed a groove 56 open outward. The groove 56 of the engagement member 52 is continuous with the groove 55 of the side frame portions 44. The groove 55 is open in the engagement groove 49.

In FIG. 21, the straight portion 48 of the intermediate connecting rod 45 is elongate in section longitudinally. At the outer circumferential surface 48b close to the surface 48a of the straight portion 48, there is provided a longitudinal projection 48c. A longitudinal groove 57 is formed on the projection 48c. The groove 57 extends to the border between the straight portion 48 and the connecting portion 47.

In FIG. 12, the stretched material 30 of the backrest 10 is formed as a mesh. The circumference 30a of the stretched material 30 is formed like a bag, and an edge member 58 is disposed therein in FIG. 19 and is sewn on. The edge member 58 comprises an elongate flat plate made of elastic synthetic resin.

In order that the stretched material 30 is stretched over the surface of the back frame 29, the engagement member 52 is engaged in the engagement groove 49 of the intermediate connecting rod 45 and fixed with a screw.

After the stretched material 30 in which the edge member 58 is sewn to the circumference 30a covers the surface 44a of the side frame portions 44 over the intermediate connecting rod 45 of the back frame 29 and covers the surface 46a of the upper frame portion 46, the edge member 58 of the stretched material 30a is pulled to the vicinity of the outer circumferential surface 44b of the side frame portion 44 by a suitable force as shown by dash lines. Then, as shown by solid lines in FIG. 19, the edge member 58 is inserted into the groove 55. Similarly, the edge member 58 on the circumference 30a of the stretched material 30 is inserted into the groove 55 of the upper frame portion 46 and into the groove 56 of the engagement member 52. The groove 57 of the straight portion 48 of the intermediate connecting rod 45 is open rearward. Thus, after the lower part of the stretched material 30 is pulled out rearward along the lower surface of the intermediate connecting rod 45, the lower edge member 58 is inserted from behind the groove 57.

The edge member 58 is pulled to the surfaces of the side frame portions 44 and the upper frame portion 46 above the intermediate connecting rod 45 by tension of the stretched material 30, so that the edge member 58 is engaged in the groove 55,56. Thus, the stretched material 30 is stretched over the surfaces of the upper frame portion 46, right and left side frame portions 44 and intermediate connecting rod 45 of the back frame 29. Between the intermediate connecting rod 45 and the lower frame portion 31, the stretched material 30 is not stretched, so a space 59 is formed between the backrest 10 and the seat 6.

In a standby position or a position of non-use in FIG. 2, the rear part of the seat 6 is raised by a force of the forcing means, and the seat 6 is positioned in the position of non-use where the seat 6 is inclined rearward and upward, and the backrest 10 is kept in a substantially upright position by extending the pushing rod 23.

In this state, when the occupant intends to sit down, the buttocks of the occupant come in contact with the first-contact portion P of the seat 6, and the seat 6 turns to the position of use in FIG. 3 against the force of the forcing means with the buttocks of the occupant to allow the buttocks of the occupant to be guided to the stable support point thereby enabling the occupant to take suitable sitting posture readily.

From the sitting position in FIG. 3, the back of the occupant leans on the backrest 10 and falls rearward, so that the backrest 10 pivots about the pivot shaft 11 to the rearward-inclined position in FIG. 4 while the pushing rod is elastically shrunk. At the beginning of the elastic shrinkage of the pushing rod 23, the rigid connecting portion 23b is pushed forward by the axial pin 27. While portion for connecting the right and left elastically-bendable portions 23b,23b to the connecting portion 23d is slightly twisted vertically, the whole elastically-bendable portions 23b,23b are elastically bent to expand outward transversely as shown by dotted lines in FIG. 9 and to vertically meander slightly.

When the back of the occupant returns forward, the backrest 10 is turned forward about the pivot shaft 11 by elastically restoring force of the pushing rod 23 to return to the original upright position.

When the occupant intends to stand up from the sitting position in FIG. 3, the seat 6 is forced to turn upward toward the position of non-use by cooperation of the elastically-extensible member 13 and elastically-bendable member 14 to assist the occupant in standing up.

The chair of the present invention achieves the following advantages:

(a) The plate spring 18 is used as forcing means for promoting the seat 6 upward thereby simplifying the structure of the forcing means and reducing the costs.

Part of the lower surface of the seat 6 away from the pivot shaft 9 can be raised by the plate spring 18 thereby increasing force for raising the rear part of the seat 6 and improving raising-assisting effect of the seat 6.

(b) The plate spring 18 turns back in the middle and becomes smaller. The distance between the part of the plate spring 18 fixed to the seat 6 and the part mounted to the base 5 becomes larger thereby increasing a moving range of the plate spring 18 and simplifying the structure of the plate spring 18

When the seat 6 turns downward, the elastically-bendable portion 18c is elastically deformed to move rearward along the lower surface of the seat 6, so that an upward force of the seat 6 by the plate spring 18 becomes uniform wherever it is positioned within the turning range of the seat 6.

(c) The width of the plate spring 18 at the lower portion 18d gradually becomes smaller forward thereby increasing a space around the lower portion 18d of the plate spring 18 and enabling the other parts to be placed within the space.

(d) The forcing means comprises a pair of plate springs 18 under the seat 6 thereby enabling the seat 6 to be supported stably by the plate springs 18,18 and increasing force of the seat 6.

(e) The right and left plate springs 18,18 are placed to become wider rearward in a plan view thereby enabling the rear part of the seat 6 to be supported stably by the plate springs 18,18.

(f) While the right and left forward portions 32,32 of the backrest 10 are elastically deformed to move away from each other, the projecting shaft 34 of the forward portion 32 of the backrest 10 is engaged in the engagement hole 38 at the rear side of the seat plate 2 from the outside, and the holding member 41 is mounted to the end face 34c of the projecting shaft 34 from the inside of the seat plate 7 to allow the seat 6 to be connected to the backrest 10 pivotally thereby greatly improving working efficiency. The engagement portion of the seat 6 with the backrest 10 is covered with the cushion material 8 as seating member thereby providing good appearance.

(g) The right and left side frame portions 44 and 44 are connected above the lower frame portion 31 via the intermediate connecting rod 45 to achieve higher strength of the back frame 29. The space 59 is produced between the intermediate connecting rod 45 and the lower frame portion 31 thereby providing good air permeability of the buttocks of the occupant.

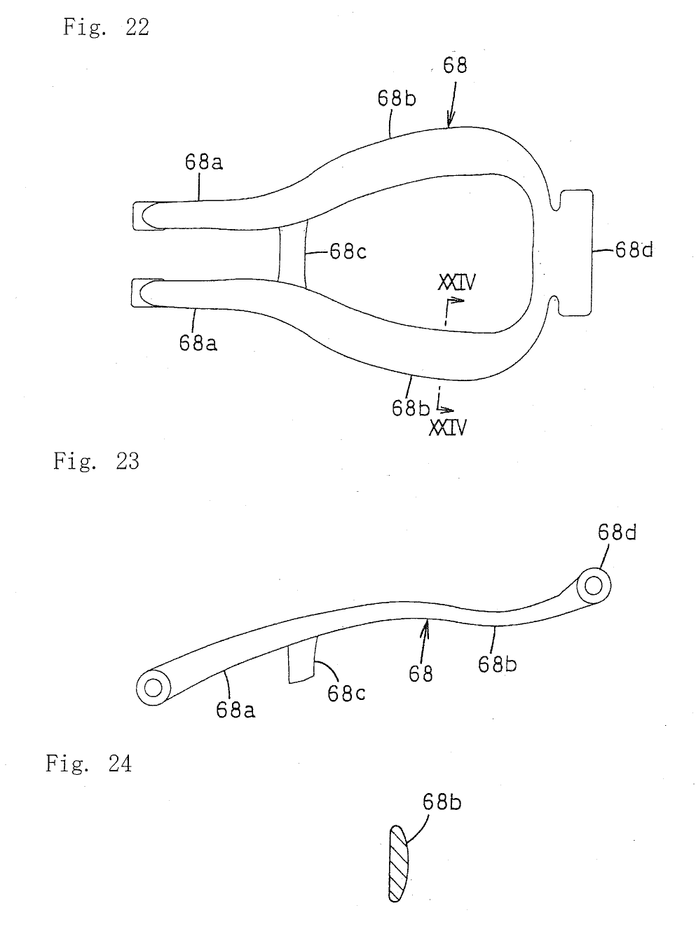

FIGS. 22-24 show a variation of a compression spring used as a pushing rod 23. The compression spring 68 in this variation is the same as the pushing rod 23 mentioned as above in the basic structure and comprises a pair of nonflexible foot portions 68a,68a; a pair of elastically-bendable portions 68b,68b at the rear of the foot portions 68a; a nonflexible hard connecting portion 68c for connecting the rear ends of the foot portions 68a; and a nonflexible hard connecting portion 68d for connecting the rear ends of the elastically-bendable portions 68b to each other.

The section of the elastically-bendable portion 68B is a rectangle having a longer side transversely of the chair, while the section of the elastically-bendable portion 68b is elliptical.

The rear part of the elastically-bendable portion 68B is curved in a side view and can elastically be bent downward at relatively large extent.

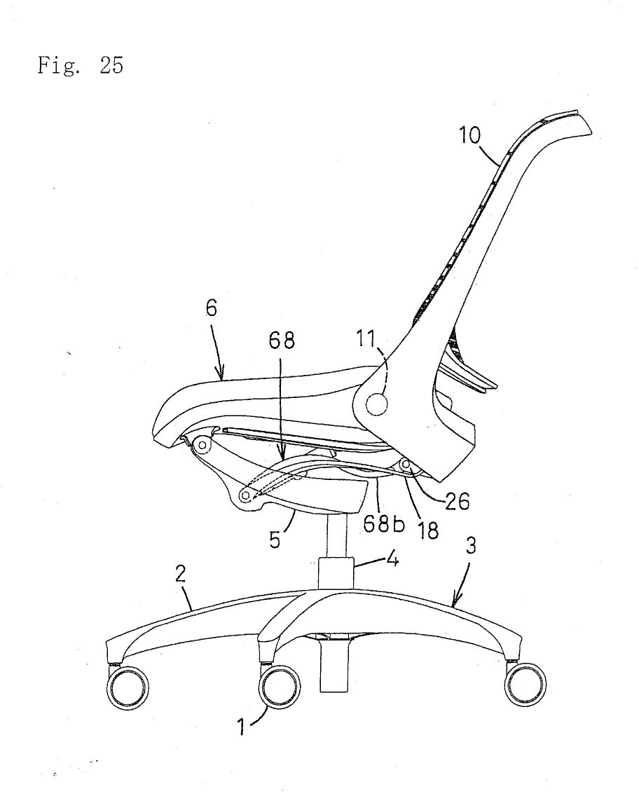

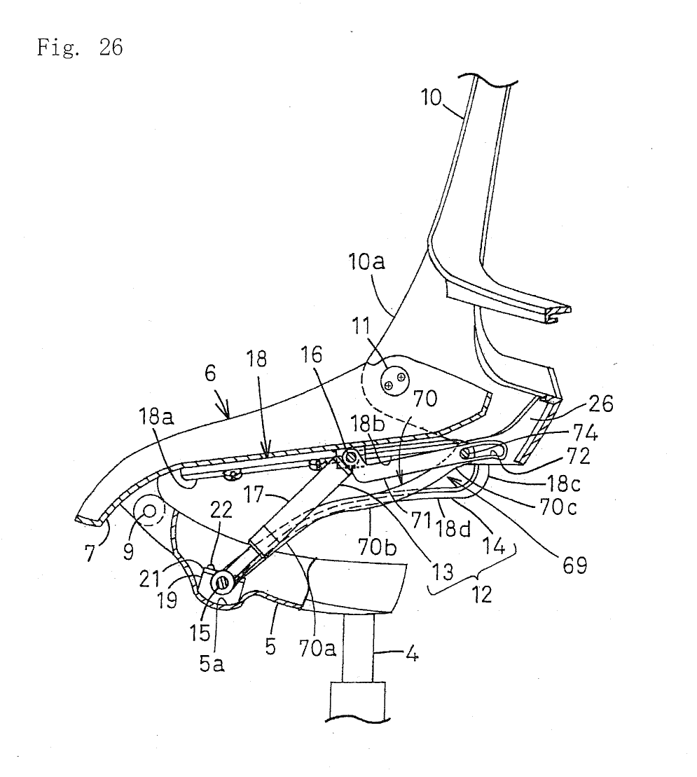

FIG. 25 is a side view of a chair in which the compression spring 68 is attached when the backrest 10 is inclined rearward. The right and left elastically-bendable portions 68b,68b are flat and curved downward like an arc. The elastically-bendable portion 68b is easily deformed elastically downward compared with the pushing rod 23, so that the base 5 and backrest 10 can be moved at a relatively large distance to enable the backrest 10 to be inclined rearward to a relatively large extent.

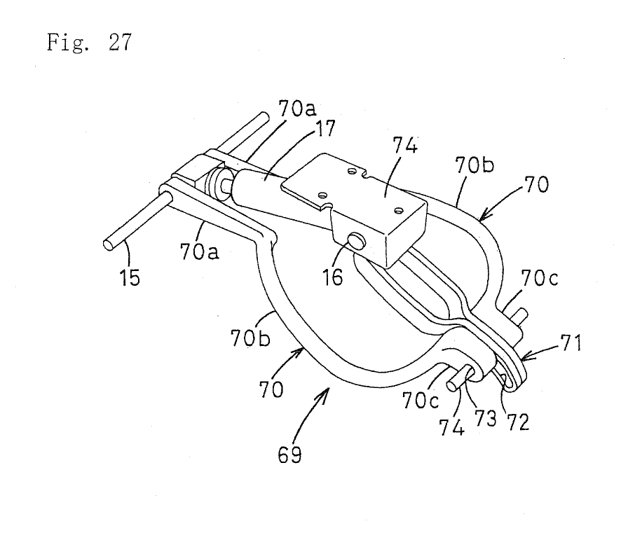

FIG. 26 shows a vertical side view of a chair of another variation of a compression spring used as a pushing rod 23, and FIG. 27 is a perspective view of a connecting portion between the compression spring and a lower part of a seat. The compression spring 69 in this variation comprises a pair of spring portions 70,70 comprising a nonflexible hard foot portion 70a; a convex elastically-bendable portion 70b extending from the rear end of the foot portion 70a; and a nonflexible hard connecting portion 70c extending from the rear ends of the elastically-bendable portions 70b, 70b.

The foot portions 70a,70a of the spring portion 70 are pivotally mounted at the front ends to the base 5 via a shaft 15 while the front end of the gas spring 17 is positioned between the front ends of the spring portion 70 as well as in the foregoing embodiments.

The rear end of a link 71 is disposed to slide between the connecting portions 70c and 70c of the spring portions 70 and is pivotally mounted to a lower bearing portion 26 of the backrest 10 via a pin 74 disposed through an elongate hole 72 and axial holes 73 of the connecting portions 70c.

The front end of the link 71 is pivotally mounted via an axial pin 16 to a mounting member 74 to which the rear end of the gas spring 17 is pivotally mounted. The mounting member 74 is attached to the lower surface of a seat plate 7. In FIG. 26, the axial pin 16 is in contact with or is close to the front end of the elongate hole 72 when the seat 6 is in a position of non-use, and is positioned at the rear end of the elongate hole 72 when the seat 6 is in a position of use.

The elastically-bendable portions 70b,70b of the right and left spring portions 70,70 of the compression spring in this variation are elastically deformed outward transversely of the chair to exhibit a spring force similar to the compression spring 23 in FIG. 9 when the backrest 10 is inclined rearward.

While the seat 6 is pivoted to the position of use, the backrest 10 is inclined rearward, so that the elastically-bendable portions 70b are elastically deformed to move the axial pin 74 from the rear end to the front end of the elongate hole 72 of the link 71.

By providing the link 71 as above, the backrest 10 is limited in a rotation range, especially the maximum rearward-inclination, and the elastically-bendable portions 70b are prevented from being elastically deformed excessively thereby improving durability of the compression spring 69. The link 71 may be applied to the chairs comprising the integrally-formed compression springs 23,68 in FIGS. 9 and 22. For example, the axial pins 16,27 are long, and the side ends of at least one of the axial pins 16,27 may be connected to each other with the link 71.

In addition to the chair for assisting the occupant to stand up, in FIG. 26, the present invention may be applied to a chair in which a pair of back rods for supporting a backrest 75 is pivotally mounted to a base at the front ends to enable the backrest 75 to be inclined rearward about the base 77.

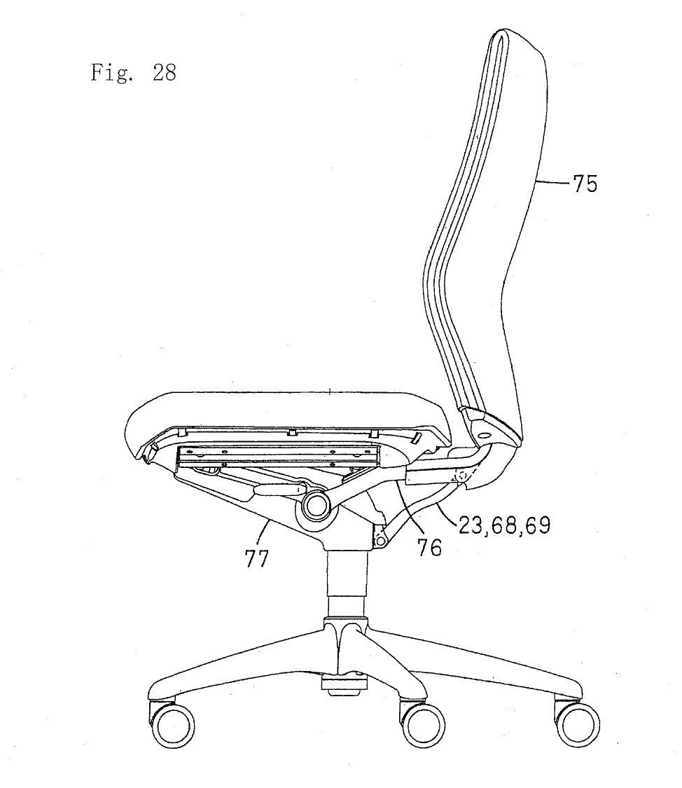

In this case, the front and rear ends of the compression springs 23,68,69 in the foregoing embodiments may be connected to the rear end of the base 77 and the lower end of the backrest 75 respectively so that the compression springs 23,68,69 may be inclined longitudinally of the chair. Other than the chair in FIG. 28, the compression spring 23,68,69 of the present invention may be applied to a chair in which the backrest is pivotally mounted to the rear end of a seat.

In such conventional chairs, a gas spring is ordinarily used to force the backrest 28. In contrast, in this invention, the compression springs 23,68 provide good appearance without exposing the gas spring from under the seat.

The compression springs 23,68 are less expensive and lighter than the gas spring thereby reducing the costs and weight of the chair.

The present invention is not limited to the foregoing embodiments. Various changes and modifications may be made without departing from the scope of claims.

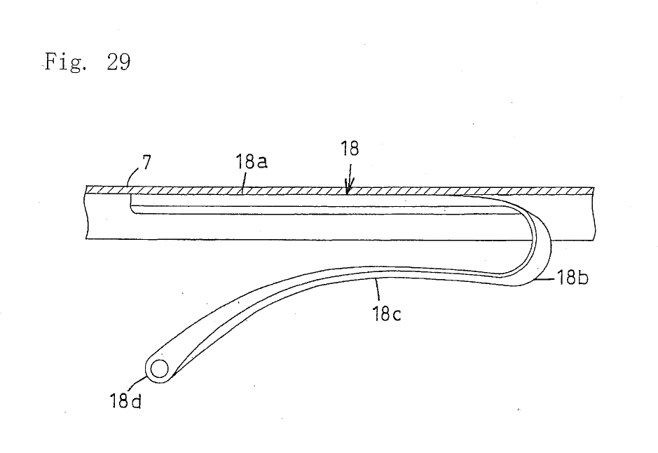

For example, in FIG. 29, a seat plate 7 and a plate spring 18 may be integrally molded so that an elongate piece 18a of the plate spring 18 is connected with the front side portions of the lower surface of the seat plate 7 made of hard synthetic resin. The plate spring 18 on the seat plate 7 is thicker by the upper piece 18a to ensure the strength.

Compared with separate forcing means between the seat and the base, this type of the structure reduces the number of parts and steps for assembling, and it is thus advantageous in costs.

One or more than two plate springs 18 may be provided.

Instead of the cushion material 8, a hard seating member may be mounted to the seat plate 7.

1. A chair comprising:
a base supported by a leg;
a seat pivotally mounted to the base via a transverse pivot shaft to allow a rear part of the seat to turn vertically; and
forcing means provided on the base to force the rear part behind the pivot shaft upward, characterized in that:
the forcing means comprises an elastically-extensible member that connects part of the base lower than the pivot shaft, to part of the seat behind the pivot shaft, and a pair of elastically-bendable members at each side of the elastically-extensible member, one end of each of the pair of elastically-bendable members being mounted to a lower surface of the seat, an intermediate part being elastically bent, the other end being mounted to part of the base lower than the pivot shaft.

2. The chair of claim 1 wherein a front end of the elastically-extensible member and a front end of a lower portion of each of the pair of elastically-bendable members are pivotally mounted to the base via a single shaft extending transversely of the chair.

3. The chair of claim 1 erg wherein the pair of elastically-bendable members becomes gradually wider to the rear in a plan view.

4. The chair of claim 1 wherein each of the pair of elastically-bendable members comprises a plate spring, one end of the plate spring being mounted to the lower surface of the seat, the other end being pivotally mounted to the base via a transverse single shaft with the front end of the elastically-extensible member.

5. The chair of claim 4 wherein an upper surface of a rear semicircular elastically-bendable portion of each of the elastically-bendable members is in contact with the lower surface of the seat so that the elastically-bendable portion of the elastically-bendable member moves rearward along the lower surface of the seat when the seat pivots downward.

6. The chair of claim 4 wherein the plate spring comprises an upper portion extending rearward from an upper mounting portion fixed to the seat; an elastically-bendable portion curved like a semicircle downward from a rear end of the upper portion so that an upper end of the elastically-bendable portion is in contact with the lower surface of the seat; a lower portion extending forward and downward from a lower end of the elastically-bendable portion; and a lower mounting portion mounted to the base at a front end of the lower portion, the plate spring being elastically bent in a U-shape and being open at a front end.

7. The chair of claim 6 wherein a width between the lower portions gradually becomes smaller forward.

8. The chair of claim 1 wherein the elastically-extensible member comprises a gas spring.

9. The chair of claim 1 wherein a lower part of the backrest is pivotally mounted to a rear part of the seat via a transverse pivot shaft so that the backrest pivots with respect to the seat between a standing position and a rearward-inclined position, the part of the base lower than the pivot shaft being connected to part of the backrest lower than the pivot shaft via an elastically-expandable pushing rod, the pushing rod pushing back a lower end of the backrest, when the seat pivots downward, to hold the backrest in the standing position, the pushing rod being elastically shrunk to enable the backrest to be inclined rearward with respect to the seat, a front end of the pushing rod being pivotally mounted to the base via a transverse shaft with the front end of the elastically-extensible member and the front end of the lower portion of the elastically-bendable member.

10. The chair of claim 9 wherein the pushing rod comprises a pair of foot portions each of which is mounted at a front end to the base at each side of the elastically-extensible member; an elastically-bendable portion extending from a rear end of each of the pair of foot portions; and a connecting portion connecting the pair of foot portions to each other under the elastically-extensible member.
